(19) United States
(12) Patent Application Publication
(10) Pub. No.: US 2011/0239760 A1
(43) Pub. Date: Oct. 6, 2011

(54) MEASURING COVER

(76) Inventor: YUN-LI SU, TAICHUNG CITY (TW)

(21) Appl. No.: 12/750,344

(22) Filed: Mar. 30, 2010

(51) Int. Cl. G01F 19/00

(52) U.S. Cl. 73/427

(57) ABSTRACT

A measuring cap used to fit on top of a container. The measuring cap includes the cap itself with a measurement section integrated to the cap. The cap includes a measuring scale for volume or the measurement section includes a measuring scale on the inside thereof. In operation, articles to be measure is poured or placed in the cap so that the cap and/or the measuring section can provide a reading of the articles. The articles can later removed from the cap.

### BACKGROUND OF THE INVENTION

1. Field of the Invention

Embodiments of the invention generally relate to a measuring cap used to fit on top of a container. Aspects of the invention specifically relate to a design of the cap of a container that is capable to be used as a measuring object for the articles to be stored in the container.

2. Background of the Invention

Currently, a cap or a lid of a container is usually used to contain articles, such as powdered milk, grounded coffee, cocoa, tea leaves, medicine, etc. in a container. Once the cap or the lid is opened, another measuring device is needed to measure the contained articles. This practice is also very common in the current marketplace in which all caps or lids are merely used provide a barrier, other than the container, between the articles and the elements. The caps or lids can be opened and closed, but fail to provide other functions. As such, if a user needs to obtain certain measurement of the articles that are removed from the container, the user must obtain a separate measuring device to identify the measurement of the removed article. For example, in trying to milk for infants, the proper concentration of the infants formula or baby formula is critical to the consuming infant. As such, as a separately sold item, a measuring cup or a measuring spoon may be used to help parents or caretaker properly measure the necessary amount of the formula before the formula is further poured into a hot water bottle to be dissolved.

As described above, the caps or lids for the containers are designed for and used to merely control the access of the articles contained in the containers. While the articles are in the process of being removed from the containers, the caps or lids are completely exposed to the elements. This situation causes the caps or lids be contaminated by dirt or a mixture of dirt and the articles contained in the container. As a result, the moisture, bacteria, virus or other contaminants are included in the caps or lids. As the caps or lids are replaced to the container, the contaminants come into contact with the articles, which is undesirable. In another situation where measuring spoons are used, the spoons may also include contaminants when returned to the container. Furthermore, when the articles are in powder or pellet forms, a user may need different measuring devices to accomplish the measuring task.

Based on the shortfalls of existing caps or lids, an improved design of a measuring cap that both serves the purpose of a barrier between the articles in the container and the element and the purpose of measuring the articles contained therein.

### BRIEF SUMMARY OF THE INVENTION

Aspects of the invention provide a measuring cap or lid that is part of the original cap or lid of a given container. In one embodiment, the measuring cap provides the measuring scales for measuring articles for the container. This provides the convenience of use, removes the need to use an additional measuring apparatus, and conserves resources by eliminating the need to have a multi-purpose measuring unit at all times.

As such, embodiments of the invention include a cap body and a receiving unit that is integrally connected with the cap body and provides measuring scales thereon. The cap body includes indicia of a volume of the receiving unit or the receiving unit includes at least one measurement scale on the interior side of the receiving unit.

In a further embodiment, a connecting portion between the receiving unit and the cap body includes an edge. The edge includes a guiding element disposed at the connecting portion in a direction that is farthest therefrom.

In a further embodiment, the receiving unit is in a uni-body cone shape or tubular shape, whose opening is of a substantially same size as that of the cap body. In a further embodiment, a handle is disposed on the exterior of the connection portion between the receiving unit and the cap body.

In an alternative embodiment, the cap body is of a substantially rectangular or circular shape, and the opening of the cap body is of substantially a rectangular, heart or circular shape.

In another embodiment, the receiving unit includes a cup element and a plate element. The cup element is coupled to the cap body. The cup element includes one or more first set of holes at the base of the cup element. The plate element is biased against the base of the cup element or against the exterior of the cup element. The plate element includes a corresponding number of holes as the one or more first set of holes on the base of the cup element.

In a further embodiment, the plate element is disposed on the exterior of the cup element, and the cup element includes three first set of holes with each of the first set of holes being disposed in an equal angle among them. A curving opening unit is disposed among the gaps between two of the three first set of holes of the cup element. The plate element includes three second set of holes, and each of the second set of holes is positioned to correspond to each of the first set of holes of the cup element. In addition, the plate element includes a notch disposed in a position corresponding to that of the curving unit, said notch inserts through the curving opening unit and enters to the cup element.

In a further aspect, the plate element is disposed within the cup element and the cup element includes three first set of holes with each of the first set of holes being disposed in an equal angle among them. The plate element includes three second set of holes, and each of the second set of holes is positioned to correspond to each of the first set of holes of the cup element. An edge of the plate element that is farthest from the base of the cup element includes a protruding notch.

In an alternative aspect, the cap body is of substantially a rectangular shape, and the opening of the receiving unit is of substantially a rectangular shape. The receiving unit is disposed at a corner of the cap body. A guide is disposed at a direction away from the corner where the receiving unit is disposed within the cap body.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is a perspective view of a first embodiment of the invention.

FIG. 2 is another perspective view of the first embodiment of the invention.

FIG. 3 is a perspective view of a second embodiment of the invention.

FIG. 4 is a perspective view of a third embodiment of the invention.

FIG. 5 is another perspective view of the third embodiment of the invention.

FIG. 6 is a perspective view of a fourth embodiment of the invention.

FIG. 7 is another perspective view of the fourth embodiment of the invention.

FIG. 8 is a perspective view of a fifth embodiment of the invention.

FIG. 9 is another perspective view of the fifth embodiment of the invention.

FIG. 10 is an exploding view of a sixth embodiment of the invention.

FIG. 11 is a perspective assembled view of the sixth embodiment of the invention.

FIG. 12 is a perspective view of the sixth embodiment used in a bottle.

FIG. 13 is an exploding view of a seventh embodiment of the invention.

FIG. 14 is a perspective assembled view of the seventh embodiment of the invention.

Corresponding reference characters indicate corresponding parts throughout the drawings.

### DETAILED DESCRIPTION OF THE INVENTION

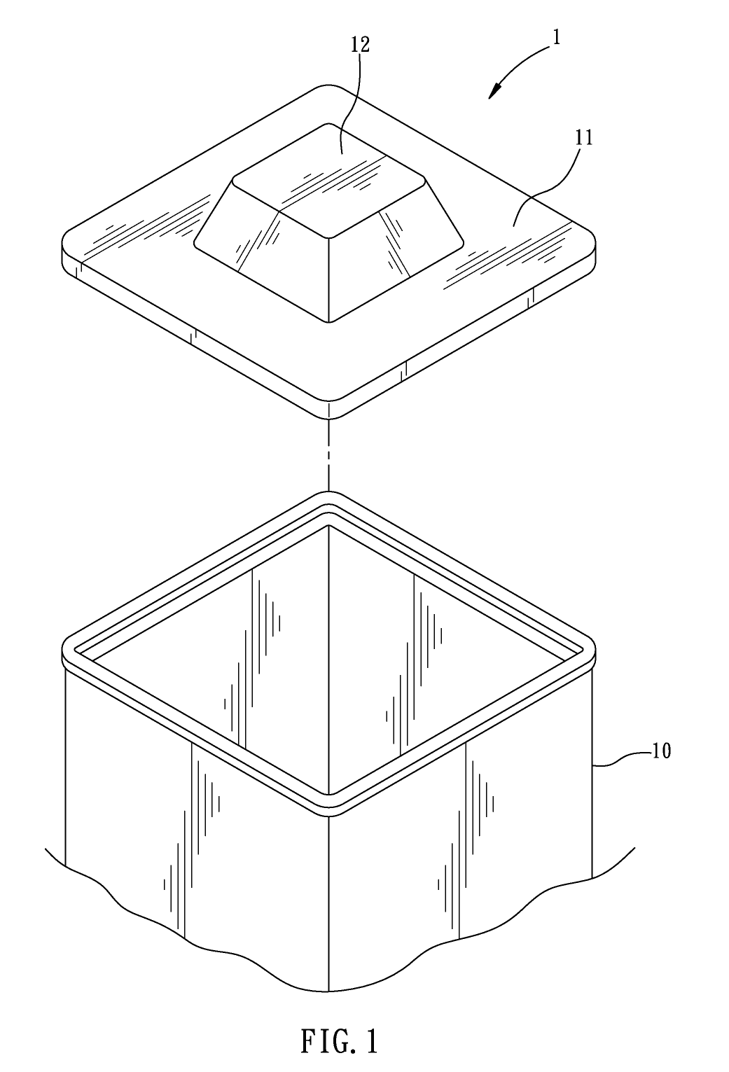

The following list shows reference characters used through FIGS. 1-14:

| | |
|---|---|
| 1-measuring cap | 11-cap body |
| 12-receiving unit | 13-guide |
| 2-measuring cap | 21-cap body |
| 22-receiving unit | 23-guide |
| 3-measuring cap | 31-cap body |
| 32-receiving unit | 33-guide |
| 4-measuring cap | 41-cap body |
| 42-receiving unit | 43-guide |
| 5-measuring cap | 51-cap body |
| 53-receiving unit | 53-handle |
| 6-measuring cap | 61-cap body |
| 62-receiving unit | 63-cup element |
| 631-first set of holes | 632-through element |
| 64-plate element | 641-second set of holes |
| 642-notch | |
| 7-measuring cap | 71-cap body |
| 72-receiving unit | 73-cup element |
| 731-first set of holes | 74-plate element |
| 741-second set of holes | 742-notch |
| 10-container | 30-container |
| 60-bottle | |

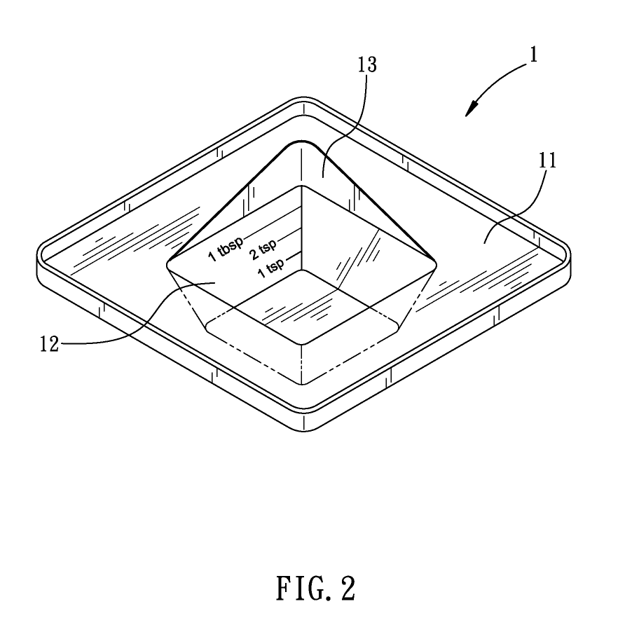

Referring to FIGS. 1 and 2, perspective views illustrate embodiments of the invention for practicing it with one container. The measuring cap 1 is to be placed on top of a container 10. The container 10 may be a container for dried milk, powdered or grounded coffee, a sealed container that is suitable for being a receptacle for powdered, grounded or liquid article. It is to be understood that examples above of the container 10 is for illustration purpose and not for limitation.

The measuring cap 1 includes a cap body 11, a receiving/measuring unit 12. The cap body 11 may be in the shape of a rectangular, circular or other shape. The cap body 11 may be in a shape that is suitable to match to that of the container 12. It is also understood that the shape example above of the cap body 11 is for illustration purpose and not for limitation. In another embodiment, the receiving/measuring unit 12 is not limited to one receiving/measuring unit 12, and the shape of the receiving/measuring unit 12 may be of any shape, including rectangular, circular, heart-shape or irregular shaped. In the example illustrated in this embodiment, the cap body 11 is of a rectangular shape and one receiving/measuring unit 12 is used.

The receiving/measuring unit 12 is rectangular in shape and is coupled to the cap body 11, and is disposed in a recess position in the center of the cap body 11. As such, the receiving/measuring unit 12 is coupled to the cap body 11 via a trough or groove. The receiving/measuring unit 12 includes one or more measuring scale units in the interior, for example, ml/c.c., ounce, teaspoon, and tablespoon. For example, one tablespoon is 5 c.c. and the following illustrations use teaspoon and tablespoon as examples.

In operation, the articles are poured into the container 10 through the receiving/measuring unit 12 of the measuring cap 1. As such, the volume of the articles is measured via the scale of the receiving/measuring unit 12. Once the desirable volume is reached, the articles can be poured to other receptacles using the measuring cap 1. As such, the measuring cap 1 of the container achieves efficiency and does not require additional equipment/resources in measuring the articles, hence conserve resources and save the environment.

Also, the measuring cap 1 is also convenient in pouring article out. The receiving/measuring unit 12 and the cap body 11 include at least one side edge that includes a guide 13 to guide the articles when exiting the container 10.

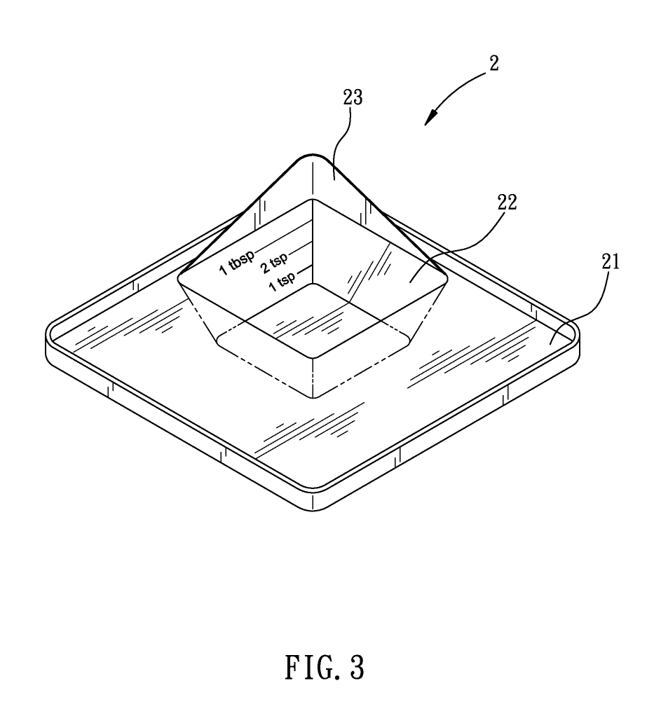

Referring now to FIG. 3, a perspective view illustrates a second embodiment of the invention. The measuring cap 2 includes a cap body 21 and a receiving/measuring unit 22. The cap body 21 may be in the shape of a rectangular, circular or other shape. The cap body 21 may be in a shape that is suitable to match to that of the container 22. It is also understood that the shape example above of the cap body 21 is for illustration purpose and not for limitation. In another embodiment, the receiving/measuring unit 22 is not limited to one receiving/measuring unit 22, and the shape of the receiving/measuring unit 22 may be of any shape, including rectangular, circular, heart-shape or irregular shaped. In the example illustrated in this embodiment, the cap body 21 is of a rectangular shape and one receiving/measuring unit 22 is used.

The receiving/measuring unit 22 is rectangular in shape and is coupled to the cap body 21, and is disposed in a recess position in the center of the cap body 21. As such, the receiving/measuring unit 22 is coupled to the cap body 21 via a trough or groove. The receiving/measuring unit 22 includes one or more measuring scale units in the interior, for example, ml/c.c., ounce, teaspoon, and tablespoon. For example, one tablespoon is 5 c.c. and the following illustrations use teaspoon and tablespoon as examples.

Also, the receiving/measuring unit 22 and the cap body 21 include at least one side edge that includes a guide 23 to guide the articles when exiting the container 10, as shown in FIG. 1.

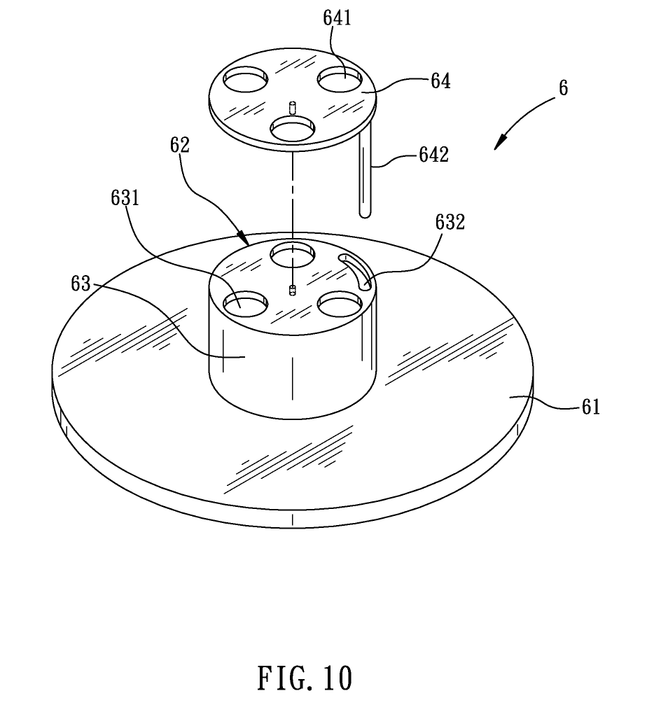

In operation, the articles are poured into the container 10 through the receiving/measuring unit 22 of the measuring cap 2. As such, the volume of the articles is measured via the scale of the receiving/measuring unit 22 or the receiving/measuring unit 22 measures the articles from the container 10 as they are replaced from the container 10 (as shown in FIG. 10). Once the desirable volume is reached, the articles can be poured to other receptacles using the measuring cap 2 or via the guide 23 to other receptacles. As such, the measuring cap 2 of the container achieves efficiency and does not require additional equipment/resources in measuring the articles, hence conserve resources and save the environment.

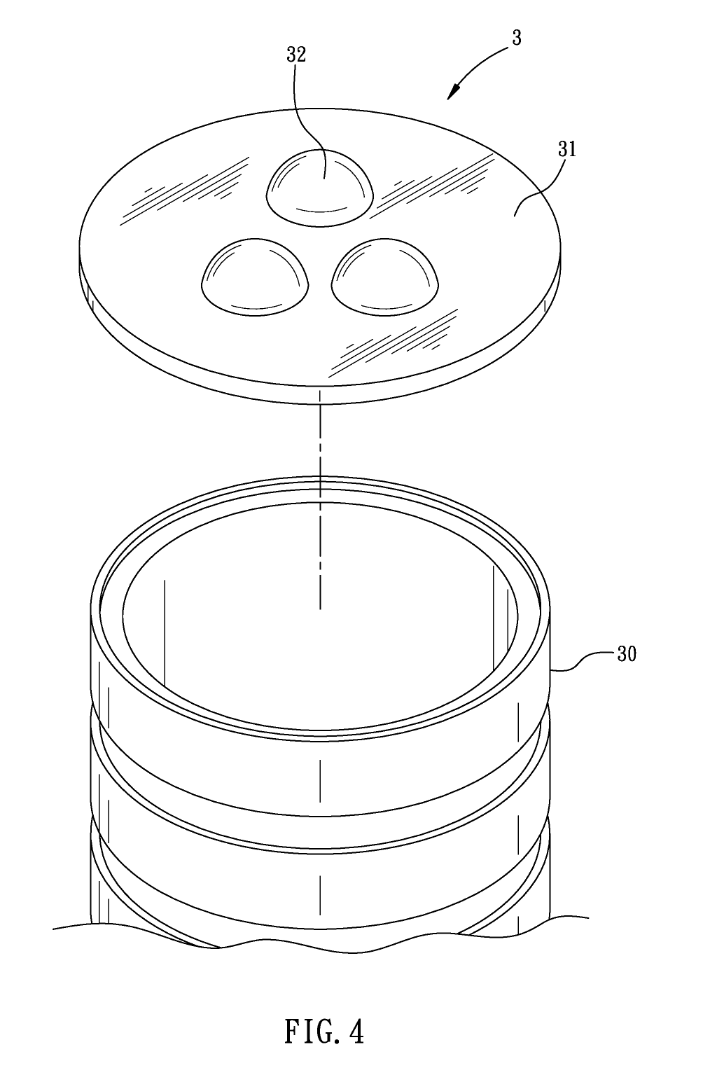

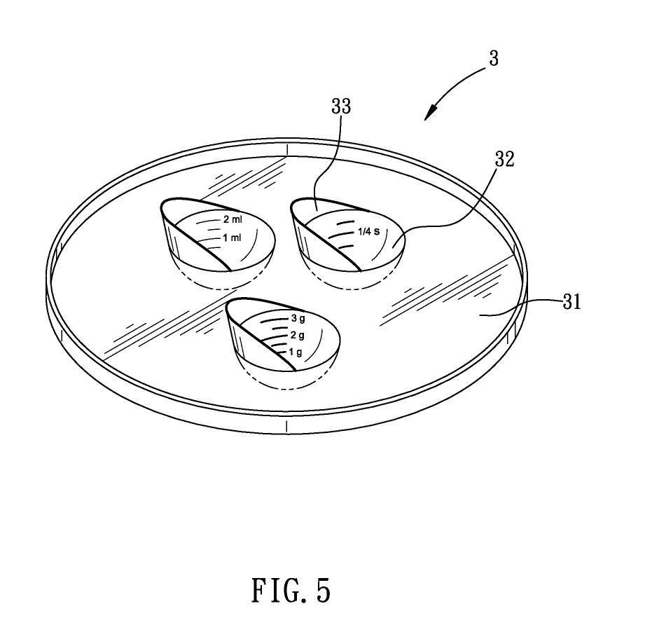

Please also refer to FIGS. 4 and 5 for a third embodiment of the invention to be described below.

A measuring cap 3 is to be placed on top of a container 30. The container 30 may be a container for dried milk, powdered or grounded coffee, a sealed container that is suitable for being a receptacle for powdered, grounded or liquid article. It is to be understood that examples above of the container 30 is for illustration purpose and not for limitation.

In this embodiment, the measuring cap 3 includes a cap body 31 and a receiving/measuring unit 32. The cap body 31 may be in the shape of a rectangular, circular or other shape. The cap body 31 may be in a shape that is suitable to match to that of the container 32. It is also understood that the shape example above of the cap body 31 is for illustration purpose and not for limitation. In another embodiment, the receiving/measuring unit 32 is not limited to one receiving/measuring unit 32, and the shape of the receiving/measuring unit 32 may be of any shape, including rectangular, circular, heart-shape or irregular shaped. In the example illustrated in this embodiment, the cap body 31 is of a circular shape and three receiving/measuring units 32 are used.

The receiving/measuring units 32 are of a circular shape and is coupled to the cap body 31. The receiving/measuring units 32 are disposed in equal angle among themselves about the center of the cap body 31 and each of the receiving/measuring units 32 includes a measuring scale. The measuring scale may include a scale for ml/c.c., ounce, teaspoon, and tablespoon.

In operation, the articles are poured into the container 30 through the receiving/measuring unit 32 of the measuring cap 3. As such, the volume of the articles is measured via the scale of the receiving/measuring unit 32 or the receiving/measuring unit 32 measures the articles from the container 30 as they are replaced from the container 30. As such, the measuring cap 3 of the container achieves efficiency and does not require additional equipment/resources in measuring the articles, hence conserve resources and save the environment.

Also, the receiving/measuring unit 32 and the cap body 31 include at least one side edge that includes a guide 33 to guide the articles when exiting the container 30.

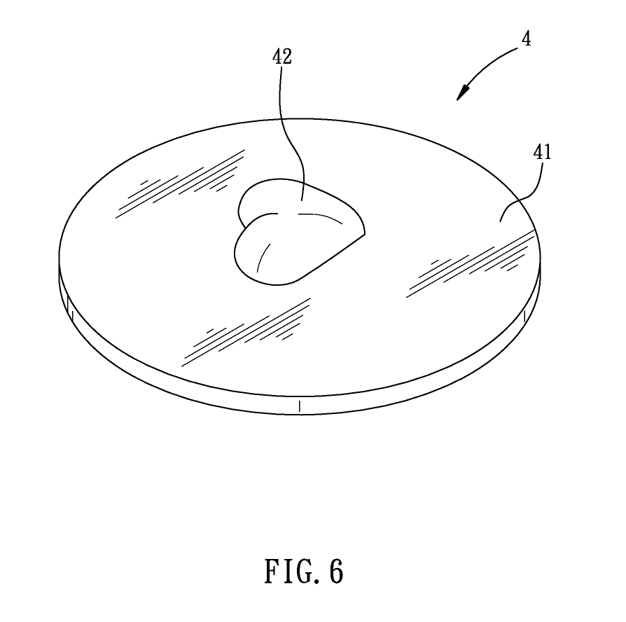

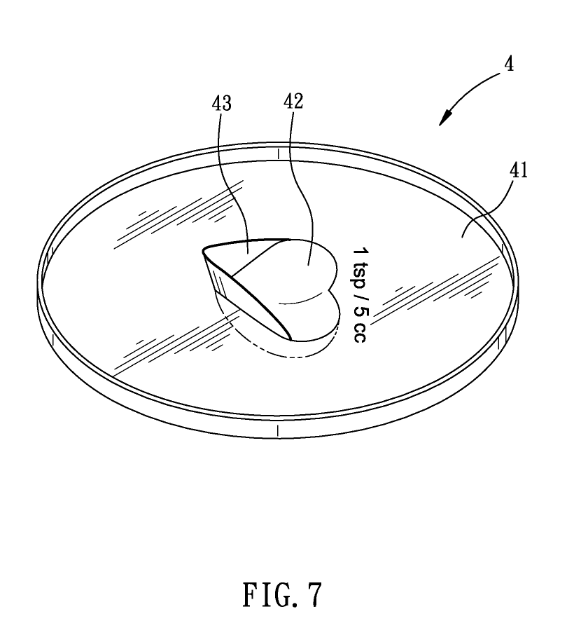

Referring now to FIGS. 6 and 7, perspective views illustrate a fourth embodiment of the invention. In this embodiment, the measuring cap 4 includes a cap body 41 and a receiving/measuring unit 42. The cap body 41 may be in the shape of a rectangular, circular or other shape. The cap body 41 may be in a shape that is suitable to match to that of the container 42. It is also understood that the shape example above of the cap body 41 is for illustration purpose and not for limitation. In another embodiment, the receiving/measuring unit 42 is not limited to one receiving/measuring unit 42, and the shape of the receiving/measuring unit 42 may be of any shape, including rectangular, circular, heart-shape or irregular shaped. In the example illustrated in this embodiment, the cap body 41 is of a circular shape and one receiving/measuring unit 42 is used.

A measuring cap 4 is to be placed on top of a container 30, see also FIG. 4. The container 30 may be a container for dried milk, powdered or grounded coffee, a sealed container that is suitable for being a receptacle for powdered, grounded or liquid article.

In this embodiment, the receiving/measuring unit 42 is of a heart shape and is coupled to the cap body 41. In one example, the receiving/measuring unit 42 is disposed at the center of the cap body 41 and includes a measuring scale (not shown) on the interior wall thereof. The measuring scale includes ml/c.c., ounce, teaspoon, and tablespoon. In this embodiment, ml/cc and teaspoon scales are used as an example.

In operation, the articles are poured into the container 30 (as in FIG. 4) through the receiving/measuring unit 42 of the measuring cap 4. As such, the volume of the articles is measured via the scale of the receiving/measuring unit 42 or the receiving/measuring unit 42 measures the articles from the container 30 as they are replaced from the container 30. As such, the measuring cap 4 of the container achieves efficiency and does not require additional equipment/resources in measuring the articles, hence conserve resources and save the environment. In addition, with a heart shaped receiving/measuring unit 42 as shown in this embodiment, the different external appearances for the measuring cap 4 increases consumer's attention and purchasing desire.

Also, in order to increase efficiencies in pouring articles out of the measuring cap 4, a guide 43 is disposed at a pointy portion of the heart shape of the receiving/measuring unit 42 as it is coupled to the cap body 41. The guide 43 is disposed at one end of the receiving/measuring unit 42 to guide the articles as they are replaced from the container 30.

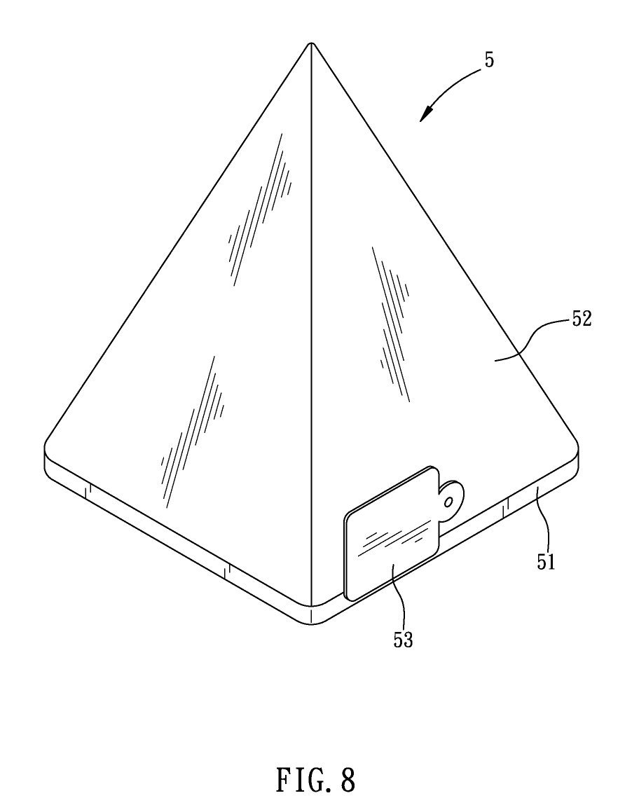

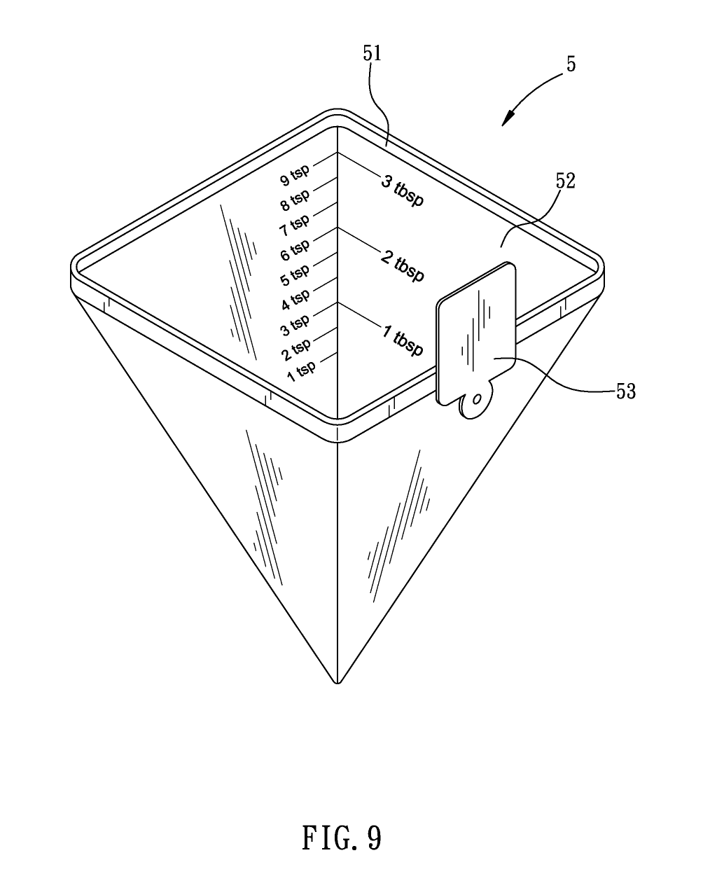

Referring now to FIGS. 8 and 9, perspective views illustrate a fifth embodiment of the invention. In this embodiment, the measuring cap 5 includes a cap body 51 and a receiving/measuring unit 52. The cap body 51 may be in the shape of a rectangular, circular or other shape. The cap body 51 may be in a shape that is suitable to match to that of the container 42. It is also understood that the shape example above of the cap body 51 is for illustration purpose and not for limitation. In this embodiment, the cap body 51 is rectangular shaped body.

In another embodiment, the receiving/measuring unit 52 is also a rectangular shape and is coupled to the cap body 51. In addition, an opening size of the receiving/measuring unit 52 matches to that of the cap body 51. In order to for a pyramid shape for the measuring cap 5, the receiving/measuring unit 52 includes at least one measuring unit, such as ml/c.c., ounce, teaspoon, and tablespoon (equivalent to 5 c.c.). In the example illustrated in this embodiment, the receiving/measuring unit 52 includes a teaspoon and a tablespoon measuring unit.

In operation, the articles are poured into the container 10 (as in FIG. 1) through the receiving/measuring unit 52 of the measuring cap 5. As such, the volume of the articles is measured via the scale of the receiving/measuring unit 52. Once the desirable volume is reached, the articles can be poured to other receptacles using the measuring cap 5. As such, the measuring cap 5 of the container achieves efficiency and does not require additional equipment/resources in measuring the articles, hence conserve resources and save the environment.

In addition, on the external surface of a connection between the receiving/measuring unit 52 and the cap body 51 includes a handle 53. When not using the cap body 51, the handle 53 is in a closed position. The closed position of the handle 53 is tapered to the side of the receiving/measuring unit 52. On the other hand, when a user wishes to use the cap body 51 and the receiving/measuring unit 52, the handle 53 is changed to an open position as a handle for the user to hold the cap body 51.

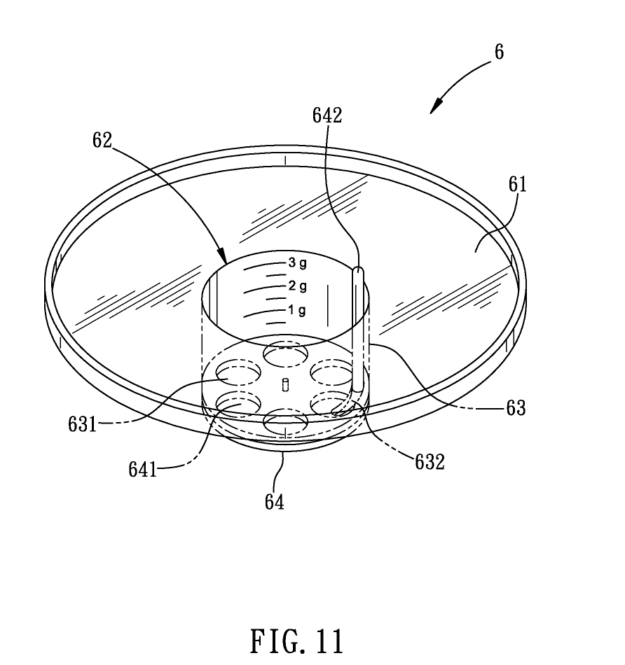

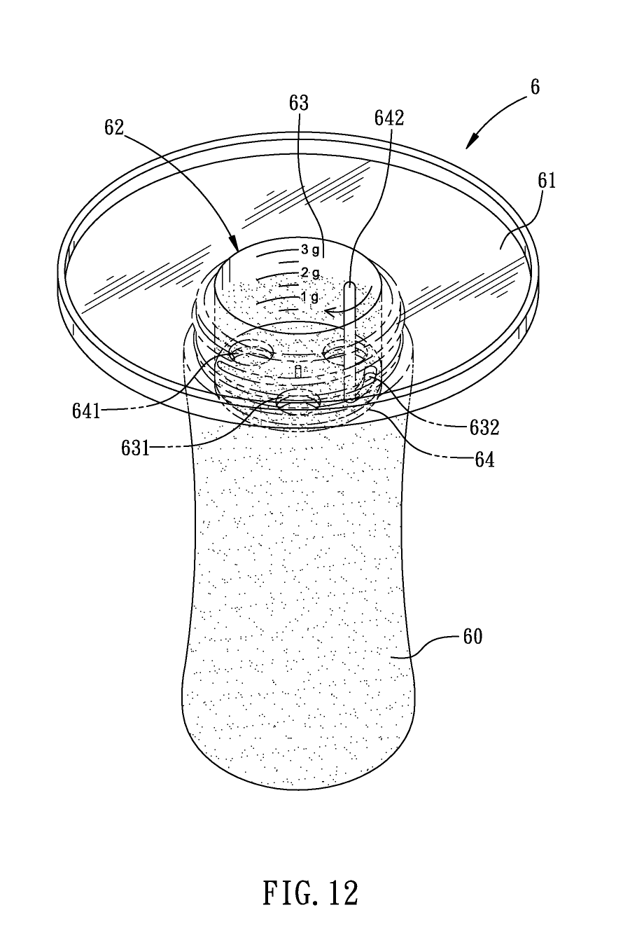

Referring now to FIGS. 10-12, perspective views illustrate a sixth embodiment of the invention. In particular, FIG. 10 illustrates an exploding view of the sixth embodiment, FIG. 11 illustrates an assembled view of the sixth embodiment from another angle and FIG. 12 illustrates a perspective view of the sixth embodiment in a bottle.

The measuring cap 6 is to be placed on top of a container 30. The container 10 may be a container for dried milk, powdered or grounded coffee, a sealed container that is suitable for being a receptacle for powdered, grounded or liquid article.

The measuring cap 6 includes a cap body 61, a receiving/measuring unit 62. The cap body 61 may be in the shape of a rectangular, circular or other shape. The cap body 61 may be in a shape that is suitable to match to that of the container 62. It is also understood that the shape example above of the cap body 61 is for illustration purpose and not for limitation. In another embodiment, the receiving/measuring unit 62 is not limited to one receiving/measuring unit 62, and the shape of the receiving/measuring unit 62 may be of any shape, including rectangular, circular, heart-shape or irregular shaped. In the example illustrated in this embodiment, the cap body 61 is of a circular shape and one receiving/measuring unit 62 is used.

In another embodiment, the receiving/measuring unit 62 is also a circular shape and is coupled to the cap body 61. The receiving/measuring unit 62 includes at least one measuring unit, such as ml/c.c., ounce, gram, teaspoon, and tablespoon (equivalent to 5 c.c.). In the example illustrated in this embodiment, the receiving/measuring unit 62 includes a measuring unit of grams.

The receiving/measuring unit 62 includes a cup element 63 and a plate element 64. The cut element 63 is coupled to the cap body 61. The bottom of the cup element 63 includes at least one first set of holes 631 (this embodiment illustrates 3 first set of holes as an example). The plate element 64 is capable of rotatably coupled to the external surface of the bottom of the cup element 63. The plate element 64 includes a second set of holes 642 that is corresponding to the first set of holes 631.

The three first set of holes 631 are disposed at equal distance/angle among them and between two of the three first set of holes 631 includes a through element 632. The plate element 64, as having a corresponding number of second set of holes 641 to the first set of holes 631, includes a notch 642 such that the notch 642 extends to the interior of the cup element 63 through the through element 632.

In operation, the receiving/measuring unit 62 is first used to measure the articles. As the receiving/measuring unit 62 has its opening available to receive the articles with the first set of holes 632 not matched to the second set of holes 642. The articles in the container 30 (see FIG. 4) is replaced and poured to the receiving/measuring unit 62 of the measuring cap 6. As such, the articles' volume can be measured using the measuring units on the wall of the receiving/measuring unit 62. Once the articles have reached the desirable volume according to the measuring units, the receiving/measuring unit 62 is moved to the opening of a bottle 60 or the cup element 63 of the receiving/measuring unit 62 is moved within the opening of the bottle 60. Next, the notch 642 is moved or biased as the plate element 64 is rotated so that the notch 642 moves along the through element 632. As such, each of the first set of holes 631 and each of the second set of holes 641 overlap with each other. As a result, the articles in the receiving/measuring unit 62 fall through the overlapped first set of holes 631 and the second set of holes 642 into the bottle 60. As such, the measuring cap of the container achieves efficiency and does not require additional equipment/resources in measuring the articles, hence conserve resources and save the environment.

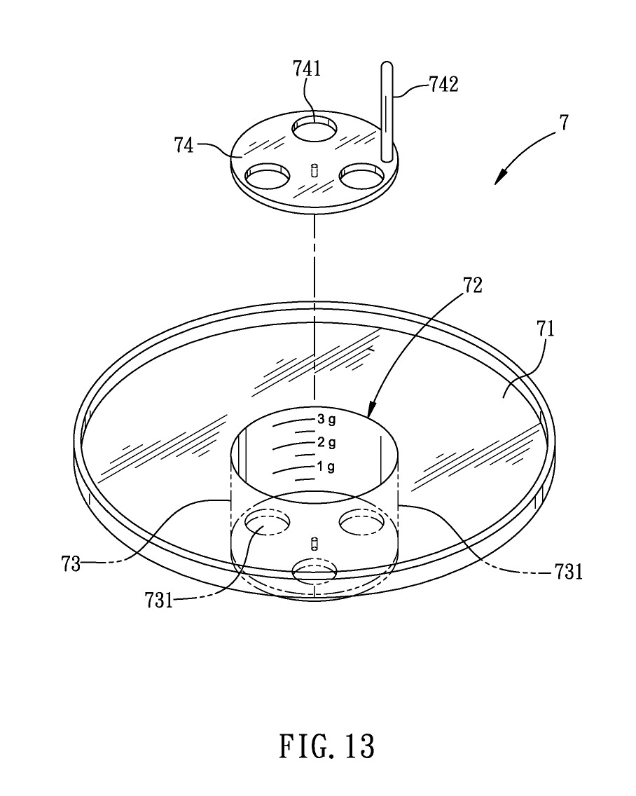

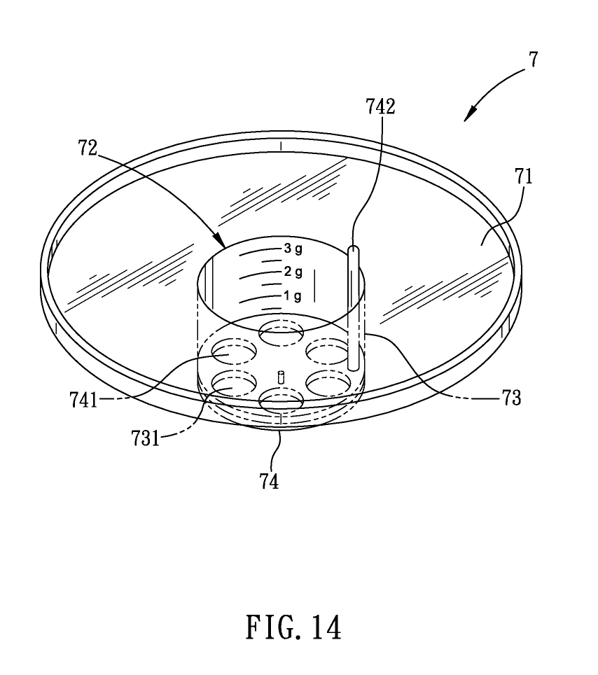

Also, referring to FIGS. 13 and 14. FIG. 13 illustrates an exploding view of a seventh embodiment, and FIG. 14 illustrates an assembled view of the seventh embodiment of the invention from a different angle.

The measuring cap 7 is to be placed on top of a container 30 (see also FIG. 4). The container 30 may be a container for dried milk, powdered or grounded coffee, a sealed container that is suitable for being a receptacle for powdered, grounded or liquid article.

The measuring cap 7 includes a cap body 71, a receiving/measuring unit 72. The cap body 71 may be in the shape of a rectangular, circular or other shape. The cap body 71 may be in a shape that is suitable to match to that of the container 72. It is also understood that the shape example above of the cap body 71 is for illustration purpose and not for limitation. In another embodiment, the receiving/measuring unit 72 is not limited to one receiving/measuring unit 72, and the shape of the receiving/measuring unit 72 may be of any shape, including rectangular, circular, heart-shape or irregular shaped. In the example illustrated in this embodiment, the cap body 71 is of a circular shape and one receiving/measuring unit 72 is used.

In another embodiment, the receiving/measuring unit 72 is also a circular shape and is coupled to the cap body 71. The receiving/measuring unit 72 includes at least one measuring unit, such as ml/c.c., ounce, gram, teaspoon, and tablespoon (equivalent to 5 c.c.). In the example illustrated in this embodiment, the receiving/measuring unit 72 includes a measuring unit of grams.

The receiving/measuring unit 72 includes a cup element 73 and a plate element 74. The cut element 73 is coupled to the cap body 71. The bottom of the cup element 73 includes at least one first set of holes 731 (this embodiment illustrates 3 first set of holes as an example). The plate element 74 is capable of rotatably coupled to the external surface of the bottom of the cup element 73. The plate element 74 includes a second set of holes 742 that is corresponding to the first set of holes 731.

The three first set of holes 731 are disposed at equal distance/angle among them and between two of the three first set of holes 731 includes a through element 732. The plate element 74, as having a corresponding number of second set of holes 741 to the first set of holes 731, includes a notch 742 such that the notch 742 extends to the interior of the cup element 73 through the through element 732.

In operation, the receiving/measuring unit 72 is first used to measure the articles. As the receiving/measuring unit 72 has its opening available to receive the articles with the first set of holes 732 not matched to the second set of holes 742. The articles in the container 30 (see FIG. 4) is replaced and poured to the receiving/measuring unit 72 of the measuring cap 7. As such, the articles' volume can be measured using the measuring units on the wall of the receiving/measuring unit 72. Once the articles have reached the desirable volume according to the measuring units, the receiving/measuring unit 72 is moved to the opening of a bottle 60 or the cup element 73 of the receiving/measuring unit 72 is moved within the opening of the bottle 60. Next, the notch 742 is moved or biased as the plate element 74 is rotated so that the notch 742 moves along the through element 732. As such, each of the first set of holes 731 and each of the second set of holes 741 overlap with each other. As a result, the articles in the receiving/measuring unit 72 fall through the overlapped first set of holes 731 and the second set of holes 742 into the bottle 60. As such, the measuring cap of the container achieves efficiency and does not require additional equipment/resources in measuring the articles, hence conserve resources and save the environment.

Also, with the above embodiments and examples, the receiving/measuring unit may be modified to protrude from the cap body. That is, the coupling between the receiving/measuring unit and the cap body may be modified include a combination of protruding and/or recessing parts thereto to couple the two parts. However, above examples are not for limiting purposes and other modifications or methods of coupling may be achieved without departing from the scope of the invention.

Although the invention has been explained in relation to its various embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

Having described the invention in detail, it will be apparent that modifications and variations are possible without departing from the scope of the invention defined in the appended claims.

When introducing elements of the embodiments(s) of the present invention, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions or products without departing from the scope of the invention, it is intended that all matter contained in the above description and shown in the accompanying drawing[s] shall be interpreted as illustrative and not in a limiting sense.

What is claimed is:

1. A measuring cap, comprising:
a cap body; and
a measuring unit, said measuring unit being coupled to the cap body.

2. The measuring cap of claim 1, wherein the measuring unit includes a guide along an edge on a coupling between the measuring unit and the cap body, said edge being disposed in a direction farthest from the measuring unit.

3. The measuring cap of claim 1, wherein the cap body comprises a shape of one of the following: rectangular and circular, and wherein the measuring unit further comprises an opening of one of the following shape: rectangular, heart-shape, circular, and irregular-shape.

4. The measuring cap of claim 1, wherein the measuring unit comprises a pyramid shape, and the measuring unit comprises a size for said opening thereof, wherein said size is substantially the same size as that of a size of the cap body, wherein the measuring unit further comprising a handle on the external surface of the coupling between the cap body and the measuring unit.

5. The measuring cap of claim 1, wherein measuring unit further comprising a cup element and a plate element, said cut element being coupled to the cap body;
said cup element includes a bottom, said bottom including at least one first set of holes;
said plate element being capable of rotatably coupled to an external or internal surface of the bottom of the cup element;
said plate element including a second set of holes, said second set of holes being corresponding to the first set of holes;
said cup element including three first set of holes each being disposed at an equal distance or angle thereabout;
two of the three first set of holes 631 including a through element;
said plate element including three second set of holes being disposed to correspond to the three first set of holes;
said plate element further including a notch, said notch extends to the interior of the cup element through the through element,
wherein the notch is moved or biased as the plate element is rotated so that the notch moves along the through element so that each of the first set of holes and each of the second set of holes overlap with each other.

6. The measuring cap of claim 1, wherein the cap body of a rectangular plate structure, wherein the opening of the measuring unit comprises a rectangular shape, wherein the measuring unit is disposed at a corner of the cap body, said measuring unit includes a guide disposed at said corner in a direction away from the measuring unit.

7. The measuring cap of claim 1, wherein the measuring unit comprises at least a measuring unit scale on an internal wall thereof or wherein the cap body includes a measuring unit scale of the measuring unit.

8. The measuring cap of claim 1, wherein the cap body comprises at least one measuring unit recessed thereon.

9. The measuring cap of claim 1, wherein the cap body comprises at least one measuring unit protruding therefrom.

10. The measuring cap of claim 1, wherein the cap body includes at least one measuring unit recessed thereon and at least one measuring unit protruding therefrom.
